(19) United States
(12) Patent Application Publication
(10) Pub. No.: US 2004/0152036 A1
(43) Pub. Date: Aug. 5, 2004

(54) Architecture for treating teeth

(76) Inventor: Amir Abolfathi, Menlo Park, CA (US)

Correspondence Address: Bao Tran, Align Technology, 881 Martin Avenue, Santa Clara, CA, 95050, US

(21) Appl. No.: 10/241,429

(22) Filed: Sep. 10, 2002

(51) Int. Cl. A61C 3/00

(52) U.S. Cl. 433/24

(57) ABSTRACT

Systems and methods are disclosed for treating a patient's teeth using a variety of vendor tools and applications. The systems and methods scan the teeth; analyze the scanned data, plan the treatment path; and generate one or more appliances to move the teeth.

### RELATED APPLICATIONS

This application is related to U.S. patent application Ser. No. 09/169,276, filed on Oct. 8, 1998, and entitled “Computer Automated Development of an Orthodontic Treatment Plan and Appliance,” which claims priority from PCT application PCT/US98/12681, filed on Jun. 19, 1998, and entitled “Method and System for Incrementally Moving Teeth” (attorney docket number 18563-000120), which claims priority from U.S. patent application Ser. No. 08/947,080, filed on Oct. 8, 1997, which claims priority from U.S. provisional application No. 60/050,342, filed on Jun. 20, 1997, all of which are incorporated by reference into this application.

This application also is related to copending U.S. patent application Ser. Nos. 09/169,034, filed on Oct. 8, 1998, and entitled “Defining Tooth-Moving Appliances Computationally”; 09/169,036, filed on Oct. 8, 1998, and entitled “System and Method for Positioning Teeth”; 09/264,547, filed on Mar. 8, 1999, and entitled “Segmenting a Digital Dentition Model”; ______, filed on May 14, 1999, and entitled “Manipulating a Digital Dentition Model to Form Models of Individual Dentition Components” (attorney docket number 09943/009001); and ______, filed on May 14, 1999, and entitled “Digitally Modeling the Deformation of Gingival Tissue During The Course of Orthodontic Treatment” (attorney docket number 09943/010001); all of which are incorporated by reference.

### TECHNOLOGICAL FIELD

The invention relates generally to the systems and methods to assist in treating a patient.

### BACKGROUND

The invention relates generally to computer-automated development of a treatment plan and appliance for a patient.

Rapid advances in computer technology have enabled corresponding advances in digital medical and dental treatments. For example, orthodontics is the branch of dentistry that deals with the straightening of crooked teeth. Although there are many types of appliances that can be used by an orthodontist to straighten the teeth, the most common appliance is braces. Braces include a variety of appliances such as brackets, archwires, ligatures, and O-rings, and attaching braces to a patient's teeth is a tedious and time consuming enterprise requiring many meetings with the treating orthodontist. Consequently, conventional orthodontic treatment limits an orthodontist's patient capacity and makes orthodontic treatment quite expensive.

Before fastening braces to a patient's teeth, at least one appointment is typically scheduled with the orthodontist, dentist, and/or X-ray laboratory so that X-rays and photographs of the patient's teeth and jaw structure can be taken. Also during this preliminary meeting, or possibly at a later meeting, an alginate mold of the patient's teeth is typically made. This mold provides a model of the patient's teeth that the orthodontist uses in conjunction with the X-rays and photographs to formulate a treatment strategy. The orthodontist then typically schedules one or more appointments during which braces will be attached to the patient's teeth.

The formulation of the treatment strategy is typically a trial-and-error process where the orthodontist arrives at the treatment strategy using a mental model based on the orthodontist's experience and skill. Because an exact model is not available, the formulation of the treatment strategy is an art which is highly dependent on the estimates and judgments of the treating orthodontist. Moreover, once the treatment strategy has been generated, it is difficult to explain the expected result to the patient in words.

### SUMMARY

In one aspect, methods for treating a patient's teeth at a treating professional's office are disclosed. The systems and methods digitally scan a patient's teeth; analyze the scanned data; plan the treatment; fabricate a device to treat the patient; and incorporate treatment outcome as feedback.

Implementations of the above aspect may include one or more of the following. The scanner can be an intra-oral scanner. The method includes separating each tooth from the scanned teeth. The method can manipulate and set each tooth in a desired tooth position. The method can generate an image of the teeth in its desired position and merge the image of the teeth in its desired position with a patient's image.

The method can allow measurement to each tooth. The method can implement milling to each appliance from a polymeric material. The method can use thermal forming to each appliance by thermal forming a sheet polymer to form the appliance; and preparing the appliance for usage.

The method can cut, trim and polish the appliance. The method can prepare the appliance using a laser machine and a milling machine. The method can shell a negative and a positive of the appliance. The method can shell the aligner from a biocompatible resin. The methods can thermal set the appliance; applying a thermal set material to form the appliance; and preparing the appliance for use.

In another aspect, an apparatus for treating patient includes a scanner adapted to scan the patient's teeth; a computer coupled to the scanner to receive the scanned teeth and to move the scanned teeth from a first position to a second position; and a fabrication machine coupled to the computer to generate one or more appliances.

Implementations of the above aspect may include one or more of the following. The fabrication machine can mill the appliance from a block of polymeric material. The fabrication machine can be a thermal forming machine. The fabrication can be a trimming machine to receive and trim the appliances. The trimming machine can be a laser machine and a milling machine.

The fabrication machine can shell a positive and a negative version of an appliance. The fabrication machine can fabricate appliances by using a biocompatiable resin. The fabrication machine can comprise a thermal setting machine.

The method can comprise a virtual health-care electronic commerce community, including: a network to communicate information relating to the community; one or more patients coupled to the network; one or more treating professionals coupled to the network; and a server coupled to the network, the server storing data for each patient and performing patient data visualization in response to a user request.

The treating professional can view one or more of the following patient data visualization over the network: a right buccal view; a left buccal view; a posterior view; an anterior view; a mandibular occlusal view; a maxillary occlusal view; an overjet view; a left distal molar view; a left lingual view; a lingual incisor view; a right lingual view; a right distal molar view; an upper jaw view; and a lower jaw view. The treating professionals can include both dentists and orthodontists.

The method can comprise one or more partners coupled to the network. The partners can include a financing partner. The partner can include a supplier and a delivery company.

The treating professionals can perform office management operations using the server. The management operations can include one or more of the following: patient scheduling, patient accounting, and claim processing. The patients and the treating professionals can access the server using browsers.

The computer-implemented methods can perform dental-related electronic commerce, comprising: transmitting teeth data associated a patient from a dental server to a treating professional computer over the Internet upon an authorized request; displaying a three-dimensional computer model of the teeth at the treating professional computer using a browser; allowing a treating professional to manipulate the three-dimensional computer model of the teeth using the browser; transmitting the computer model from the treating professional computer to the server; and generating an appliance to treat the patient based on the computer model of the teeth.

The computer implemented methods can provide financing options for the patient using one or more financing partners. The methods can offer an on-line shop geared to the patient's dental requirements. The method can provide office management utilities for the treating professional.

The office management utilities can include one or more of the following: patient scheduling, patient accounting, and claim processing. The method can allow a treating professional to manipulate the three-dimensional computer model of the teeth using browser further comprises displaying a plurality of dental views.

The dental views include one or more of the following: a right buccal view; a left buccal view; a posterior view; an anterior view; a mandibular occlusal view; a maxillary occlusal view; an overjet view; a left distal molar view; a left lingual view; a lingual incisor view; a right lingual view; a right distal molar view; an upper jaw view; and a lower jaw view.

The method can allow a treating professional to manipulate the three-dimensional computer model of the teeth using the browser further comprises clicking on a tooth to adjust its position. The method displaying x, y and z axis can allow the treating professional to adjust the position of the tooth. The method can provide supplemental services to the patient, including teeth whitening services.

The method can provide a server to support a health-care electronic commerce community with one or more patients and one or more service providers, comprising: a processor adapted to communicate with a network; a data storage device coupled to the processor and adapted to store data for each patient; and software to communicate 3D patient data in response to a client request.

The method can be a browser adapted to receive the client request and transmitting the request to the server. The method can be a viewer plug-in to visualize patient data in 3D.

The method can provider service to one or more of the following health-care applications: dentistry applications, cosmetic augmentation, hair-care enhancements, liposuction, plastic or reconstructive surgery.

Advantages of the invention may include one or more of the following. The system provides flexibility in assembling communities of autonomous service providers. The system provides flexibility in structuring cooperative interactions among the members of a community of treatment providers and vendors. The system imposes the right amount of structure on individual vendors, and includes legacy and “owned-elsewhere” applications. The system also supports collaboration (simultaneous work over shared data and processing resources) between users and vendors. The system allows a plurality of vendors to share information so that the end objective is that a professional treatment provider (for example doctors, orthodontists and dentists) can put a system together that flexibly handles a patient's needs.

The system supports distributed execution of a user's requests, interoperability of multiple application subsystems, addition of new software applications, and incorporation of existing applications. It is transparent and users do not need to know where or how their requests are executed. The architecture is served by a multimodal interface, including pen, voice, mouse, trackball and direct manipulation.

### BRIEF DESCRIPTION OF THE DRAWINGS

FIG. 1A is a diagram of an exemplary system for treating patient.

FIG. 1B is a flowchart illustrating an exemplary process for treating patient at the professional's office.

FIG. 1C shows an exemplary system supporting patient treatment using the Internet.

FIG. 2 is a diagram of a server to support electronic commerce with the professional service provider's office.

FIG. 3 is a diagram of a web site on the server of FIG. 2.

FIG. 4 is a flowchart of a process for selecting dental services from a patient's perspective.

FIG. 5 is a flowchart of a first process for providing dental services from a treating professional's perspective.

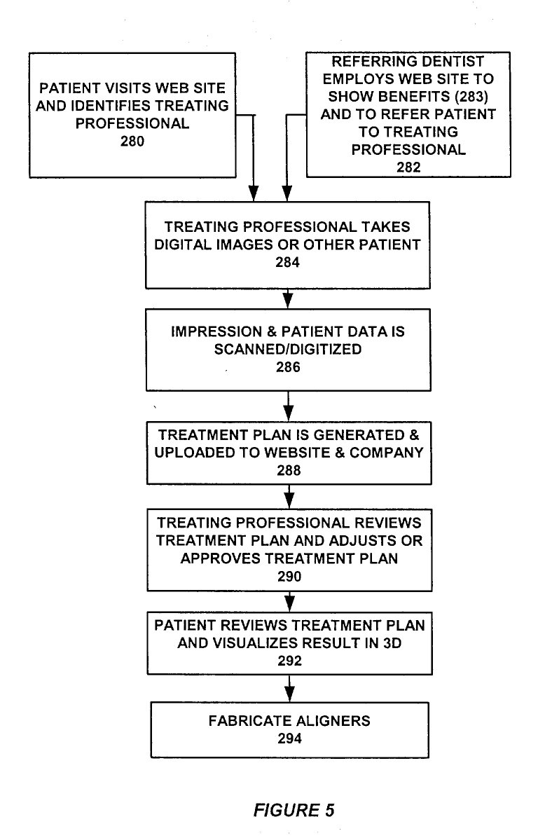

FIG. 6 is a flowchart of a second process for providing dental services from a treating professional's perspective.

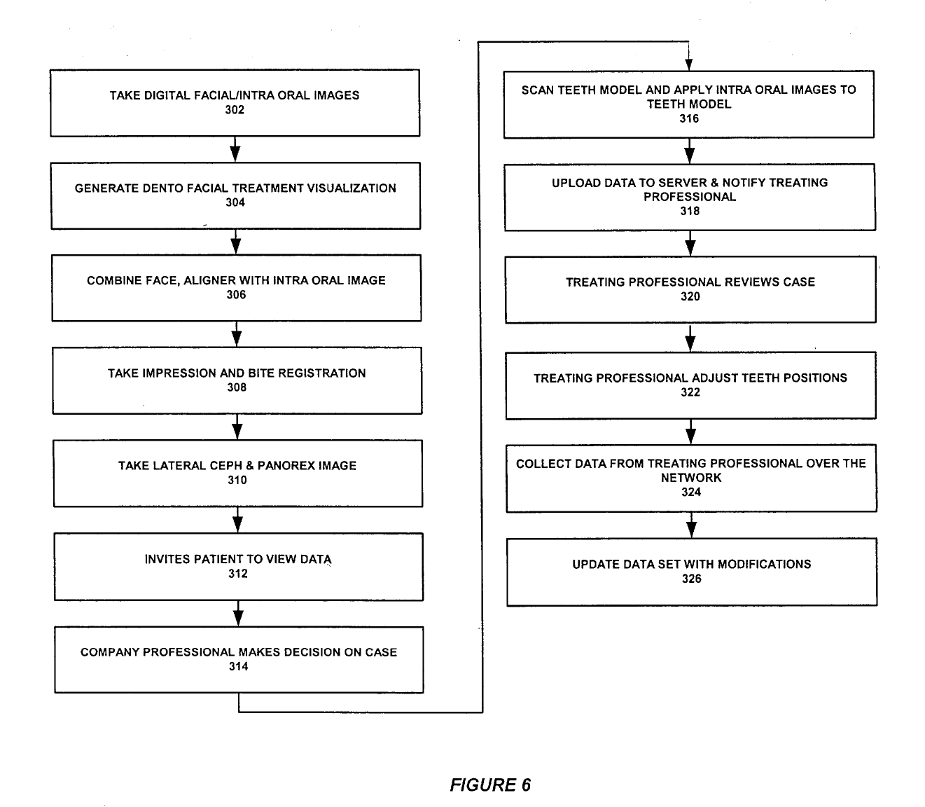

FIG. 7 is a flowchart of a process to render 3D views of a patient's teeth on a browser.

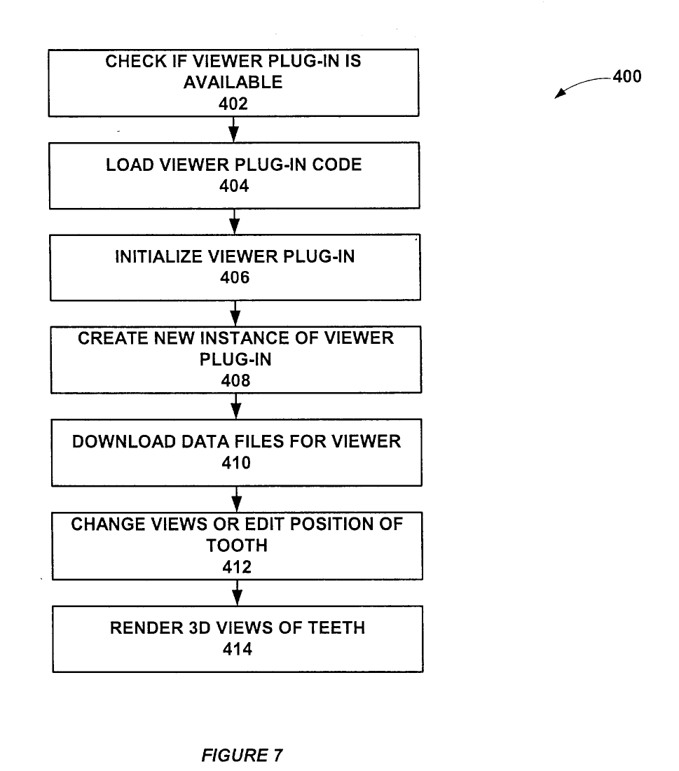

FIG. 8 is an exemplary output of the process of FIG. 7 using the browser.

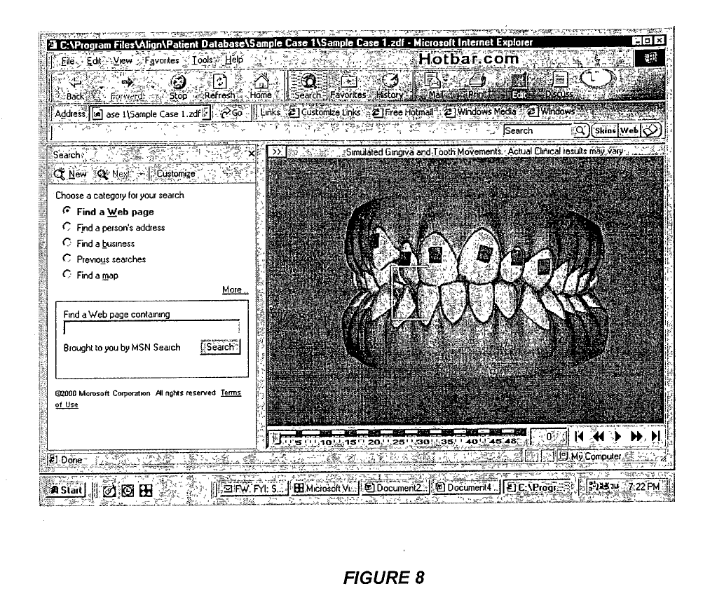

FIG. 9 is a diagram of a system for manufacturing appliances.

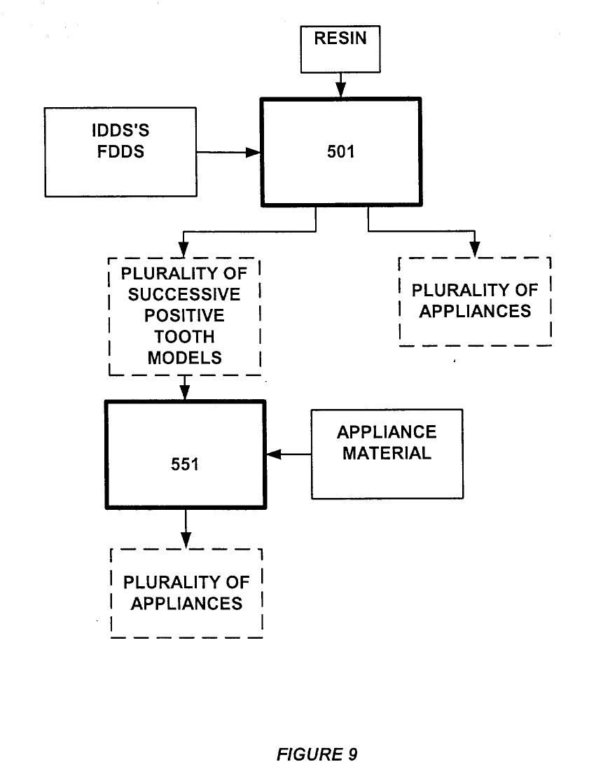

FIG. 10 is a diagram illustrating a computer system to support the fabrication of appliances.

### DESCRIPTION

In the market of leading edge technology, change is a constant, and the way a company adapts to change in the market, and how it is structured to accommodate and exploit those changes, will differentiate it from its competitors. Innovation and productivity are two key attributes for success and development. Yet flexibility is required since no single vendor can supply all requirements for all professional treatment providers.

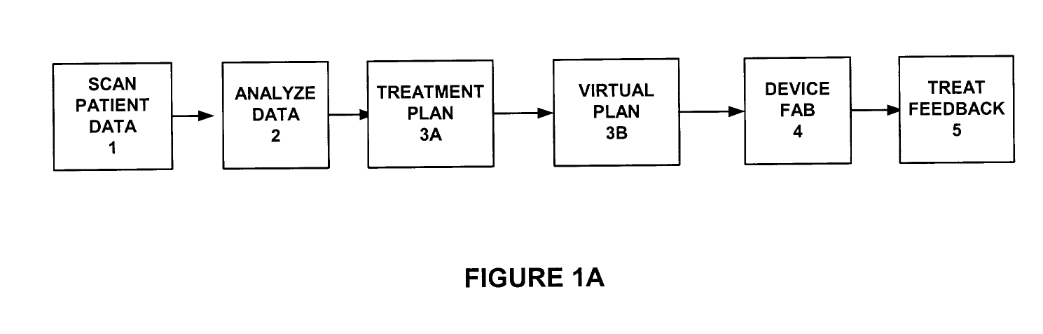

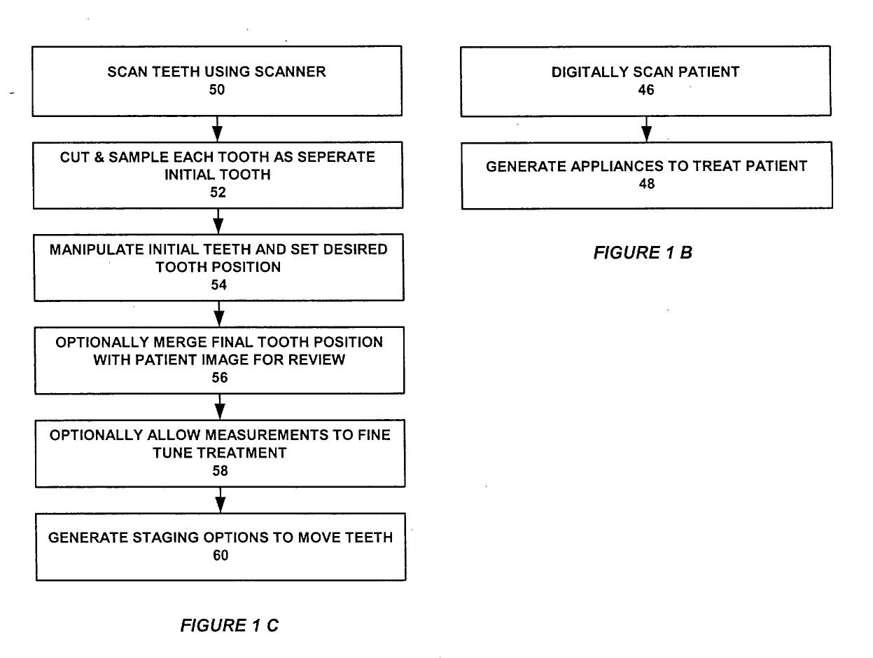

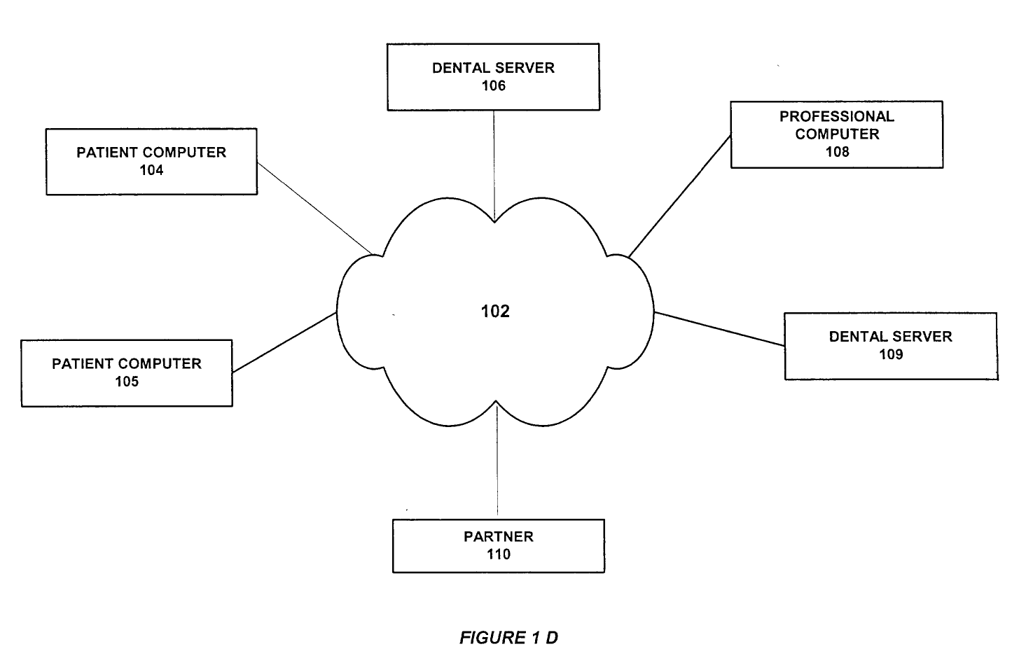

FIG. 1A shows an exemplary architecture that allows a plurality of vendors to communicate and interoperate so that a professional treatment provider (for example doctors, orthodontists and dentists) can purchase or license interchangeable components to flexibly handle a patient's needs. The components of the architecture include a data capture module 1, an analyzer module 2, a treatment planning module 3A and a virtual planning module 3B, a treatment fabrication module 4, and a treatment feedback module 5.

Each of the foregoing modules 1-6 interoperates with neighboring modules, even though the neighboring modules may come from a different vendor. The architecture partitions the functionality of the system into a set of well-defined services or functions, each with a well-defined protocol specifying the interface to that service. Some of these services are intended to support users directly; some are intended for access by machines. Thus, vendors are free to develop or use different designs and implementations of the services, as long as their interfaces are consistent with the agreed upon protocol. Furthermore, the architecture supports extending the capabilities of the system through specification of additional services. In addition to conformance to an open architecture, the system achieves interoperability specifying items such as formats, data types, and metadata conventions.

In one embodiment, XML (Extensible Markup Language) is used to share data among the modules. XML, a ‘metalanguage’—a language for describing other languages, provides a flexible and adaptable information identification to describe patient data. The files are all ASCII data, thus XML is independent of operating system, software vendor and national language. XML acts as a framework for the structured representation of data.

The system interoperates with traditional databases such as SQL database. In the dental embodiment, HTTP and SMTP servlets handle the dental workflow process which captures and processes XML information ‘packets’ between various work queues at each modules 1-5. For example, the scanned patient data generated by the data capture module 1 is automatically generated and coded (and edited if necessary), entered into the XML repository and e-mailed (as HTML) to the analyzer module 2. The process of creating an XML dental record as a sequence of individual packets allows intelligent ‘agents’ to aggregate the information for analysis, treatment planning and device fabrication.

The users and vendors collaborating through the architecture are autonomous and free to aggregate, at various levels of abstraction, whatever technologies they deem appropriate to satisfy their “customer” requirements, as long as they provide well-defined interfaces to their services that are consistent with the overall architecture. The architecture therefore presents a seamless collection of digital library capabilities to the user, achieved through a federation of individual organization's sub-blocks or sub-modules.

The open architecture supports the federation concept in two ways. First, it provides a modular construct for each user or each vendor to create its treatment system, through selection of the best technology products to serve the needs of the local users. These products will interoperate to create the treatment in a manner that is both sensitive to local user specific conditions and needs as well as consistent with the overall treatment requirements. Second, the architecture provides a means for defining the interfaces between the modules or sub-blocks in the system. This is achieved through specification of interfaces to the services provided by each of the separate libraries.

Turning now to the data capture module 1, a variety of scanners can be used to capture patient data. For dental or orthondic applications, a patient's teeth may be scanned or imaged using CCD imagers (digital cameras), X-rays, three-dimensional X-rays, computer-aided tomographic images or data sets, and magnetic resonance images.

In one method, a plaster cast of the patient's teeth is obtained and the casting is digitally scanned by a scanner, such as a non-contact type laser or destructive scanner or a contact-type scanner. The data set produced by the scanner may be presented in any of a variety of digital formats to ensure compatibility with the software used to manipulate images represented by the data, as described in more detail below. General techniques for producing plaster casts of teeth and generating digital models using laser scanning techniques are described, for example, in U.S. Pat. No. 5,605,459, the full disclosure of which is incorporated in this application by reference.

Suitable scanners include a variety of range acquisition systems, generally categorized by whether the acquisition process requires contact with the three dimensional object being scanned. Some contact-type scanners use probes having multiple degrees of translational and/or rotational freedom. A computer-readable (i.e., digital) representation of the sample object is generated by recording the physical displacement of the probe as it is drawn across the sample surface.

Conventional non-contact-type scanners include reflective-type and transmissive-type systems. A wide variety of reflective systems are in use today, some of which utilize non-optical incident energy sources such as microwave radar or sonar. Others utilize optical energy. Non-contact-type systems that use reflected optical energy usually include special instrumentation that carry out certain measuring techniques (e.g., imaging radar, triangulation and interferometry).

One type of non-contact scanner is an optical, reflective scanner, such as a laser scanner. Non-contact scanners such as this are inherently nondestructive (i.e., do not damage the sample object), generally are characterized by a relatively high capture resolution, and are capable of scanning a sample in a relatively short period of time. One such scanner is the Cyberware Model 15 scanner manufactured by Cyberware, Inc., Monterey, Calif.

Both non-contact-type and contact-type scanners also can include color cameras which, when synchronized with the scanning capabilities, provide means for capturing, in digital format, color representations of the sample objects. The importance of this ability to capture not just the shape of the sample object but also its color is discussed below.

Other scanners, such as the CSS-1000 model destructive scanner produced by Capture Geometry Inside (CGI), Minneapolis, Minn., can provide more detailed and precise information about a patient's teeth than a typical range acquisition scanner can provide. In particular, a destructive scanner can image areas that are hidden or shielded from a range acquisition scanner and therefore may not be subject to adequate imaging. The CSS-1000 scanner gathers image data for an object by repeatedly milling thin slices from the object and optically scanning the sequence of milled surfaces to create a sequence of 2D image slices, so none of the object's surfaces are hidden from the scanner. Image processing software combines the data from individual slices to form a data set representing the object, which later is converted into a digital representation of the surfaces of the object.

A patient's wax bite can be used to acquire the relative positions of the upper and lower teeth in centric occlusion. For a laser scan, this can be accomplished by first placing the lower cast in front of the scanner, with the teeth facing upwards, then placing the wax bite on top of the lower cast, and finally placing the upper cast on top of the lower cast, with the teeth facing downwards, resting on the wax bite. A cylindrical scan is then acquired for the lower and upper casts in their relative positions. The scanned data provides a digital model of medium resolution representing an object which is the combination of the patient's arches positioned in the same relative configuration as in the mouth.

The digital model acts as a template guiding the placement of the two individual digital models (one per arch). More precisely, using software, for example the CyberWare alignment software, each digital arch is in turn aligned to the pair scan. The individual models are then positioned relative to each other corresponding to the arches in the patient's mouth.

The waxbite can also be scanned separately to provide a second set of data about the teeth in the upper and lower arches. In particular, the plaster cast provides a “positive” image of the patient's teeth, from which one set of data is derived, and the waxbite provides a “negative” image of the teeth, from which a second, redundant set of data is derived. The two sets of data can then be matched to form a single data set describing the patient's teeth with increased accuracy and precision. The impression from which the plaster cast was made also can be used instead of or in addition to the waxbite.

In another embodiment, the scanner is an X-ray scanner. The scanner has a rotating table including a table top that has sufficient space for one or two impressions to rest on it. The impression can be irradiated by a flat fan-shaped X-ray beam emitted by an X-ray source. The radiation is swept by the impression and passes through a scintillator. Radiation transmitted by the scintillator is measured by an X-ray detector. The detector performs an analog to digital conversion and provides this information to a computer. The computer captures on cross sectional scan and instructs the rotating table to rotate to its next position and another scan is performed until the entire impression is scanned. The X-ray source, the scintillator, the detector and the rotatable table thus obtains an image of a cross-section of (a part of) the impression by computer tomography (CT). The CT system scans impressions of patients' teeth and eliminates the need to create a plaster model for each jaw. Software on the computer automatically extracts a positive model out of the scan data. The upper and lower jaw will then be put together using the information from the scan data of a wax bite. In one embodiment, the scanner 800 utilizes a technique called “cone beam reconstruction.” The process for digitally scanning and generating a model of the patient's teeth for treatment is as follows: Impression of a patient is taken in a plastic tray and a bite of the patient is taken. A suitable material for capturing the bite is PVS material in order to capture detailed tooth geometry. Wax bites may also be used but results can be worse based on definition on the bite. The upper, lower and the bite will be scanned together in the CT machine. Once scanned, the upper and lower impression scanned data is digitally reversed to make a positive. This is done by identifying the inner most surface of the impression material and extracting it from the rest of the data using a largest connected component algorithm. Once the upper and lower data is obtained, they will be aligned into a bite position using the bite material scanned. The models are digitally detailed. Any excess material or defects in the material will have to be cleaned up (process is known as detailing). Once the models are cleaned, the final bite needs to be set. Models are articulated by an operator till the relative position closely resembles that of the actual mouth. The model is now ready for treatment. The teeth are already cut as part of the detailing operation.

In yet another embodiment, the scanner can be an intra-oral scanner device that captures a three-dimensional images of a patient's dentition. The advantage of handheld scanning is that doctors have the flexibility to use it for intraoral scanning at chairside, or to scan plaster models before treatment planning, whichever works more effectively with the practice workflow. One such intra-oral scanner is the SureSmile OraScanner from OraMetrix of Dallas, Tex. The OraScanner uses structured white light to capture images, not laser light or x-ray technology. As a result, you can safely use the OraScanner to take multiple scans on a patient to monitor and communicate progress throughout the treatment cycle.

The system can optionally include a segmentation subsystem that performs automatic or semi-automatic segmentation of the 3D dentition model into models of individual teeth. The segmentation subsystem is advantageously implemented as one or more computer program processes implementing a segmentation process. In alternative implementations, the segmentation process can act on the 3D volume data or on the 3D surface mesh. The segmentation process applies conventional feature detection techniques tailored to exploit the characteristics and known features of teeth. For example, feature detection algorithms generally act on images in which the features to be distinguished from each other have different colors or shades of gray. Features to be detected also usually are separated spatially from each other. However, features to be detected in a 2D or 3D image of a plaster tooth casting (e.g., the individual teeth and the gum tissue) all have the same color (white), and some features, such as an individual tooth and the surrounding gum tissue, have no spatial separation.

The segmentation process can be implemented to employ any of several feature detection techniques and advantageously uses a combination of techniques to increase the accuracy of feature identification. One feature detection technique uses color analysis to distinguish objects based on variations in color. Color analysis can be used in situations where individual teeth are separated by gaps large enough for the potting material to fill. Because the tooth casting and the potting material have contrasting colors, these teeth appear in the model as white areas separated by thin strips of black.

Another feature detection technique uses shape analysis to distinguish certain features, such as tooth from gum. In general, tooth surfaces are smooth while gum surfaces have texture, and the teeth and gums typically form a U-shaped ridge where they meet. Detecting these features through shape analysis assists in distinguishing tooth from gum. Shape analysis can also detect individual teeth, for example by searching for the largest objects in the 3D image or by recognizing the cusps of a molar as four isolated patches of one color arranged in a certain pattern. One cusp-detection algorithm is described below.

Other feature detection techniques use databases of known cases or statistical information against which a particular 3D image is matched using conventional image pattern matching and data fitting techniques. One such technique, known as “Maximum a posteriori” (MAP), uses prior images to model pixel values corresponding to distinct object types (classes) as independent random variables with normal (Gaussian) distributions whose parameters (mean and variance) are selected empirically. For each class, a histogram profile is created based on a Gaussian distribution with the specified mean and variance. The prior images supply for each pixel and each class the probability that the pixel belongs to the class, a measure which reflects the relative frequency of each class. Applying Bayes' Rule to each class, the pixel values in the input image are scaled according to the prior probabilities, then by the distribution function. The result is a posterior probability that each pixel belongs to each class. The Maximum a posteriori (MAP) approach then selects for each pixel the class with the highest posterior probability as the output of the segmentation.

Another feature detection technique uses automatic detection of tooth cusps. Cusps are pointed projections on the chewing surface of a tooth. In one implementation, cusp detection is performed in two stages: (1) a “detection” stage, during which a set of points on the tooth are determined as candidates for cusp locations; and (2) a “rejection” stage, during which candidates from the set of points are rejected if they do not satisfy a set of criteria associated with cusps.

In the detection stage, a possible cusp is viewed as an “island” on the surface of the tooth, with the candidate cusp at the highest point on the island. “Highest” is measured with respect to the coordinate system of the model, but could just as easily be measured with respect to the local coordinate system of each tooth if detection is performed after the cutting phase of treatment. The set of all possible cusps is determined by looking for all local maxima on the tooth model that are within a specified distance of the top of the bounding box of the model. First, the highest point on the model is designated as the first candidate cusp. A plane is passed through this point, perpendicular to the direction along which the height of a point is measured. The plane is then lowered by a small predetermined distance along the Z axis. Next, all vertices connected to the tooth and which are above the plane and on some connected component are associated with the candidate cusp as cusps. This step is also referred to as the “flood fill” step. From each candidate cusp point, outward “flooding” is performed, marking each vertex on the model visited in this matter as “part of” the corresponding candidate cusp. After the flood fill step is complete, every vertex on the model is examined. Any vertex that is above the plane and has not been visited by one of the flood fills is added to the list of candidate cusps. These steps are repeated until the plane is traveled a specified distance.

Once each digital tooth object has been cut, the professional user or a suitable operator can then use the analyzer module 2 to manipulate and analyze the tooth objects and set a desired tooth position using the software on the computer. In one implementation, the software can superimpose the frontal view of the final desired arch form on a 2D or 3D frontal digital image of the patient to allow the treating professional to review and discuss the proposed treatment with the patient. In another embodiment, the software can process the scanned data and provide the user/operator with useful data and orthodontic measurements (e.g. arch width, arch length, tooth size, angulations) to assist the operator and or patient in fine tuning the treatment.

Turning now to the analyzer module 2, various tools are provided to help a clinician or treatment provider analyze the patient's situation. A viewer program can be used to display an image of the teeth and, if requested by the clinician, one or more images of the teeth as they will appear during/after treatment. The clinician can rotate the images in three dimensions to view the various tooth surfaces, and the clinician can snap the image to any of several predefined viewing angles. These viewing angles include the standard front, back, top, bottom and side views, as well as orthodontic-specific viewing angles, such as the lingual, buccal, facial, occlusal, and incisal views. The viewer program also includes an animation routine that provides a series of images showing the positions of the teeth at each intermediate step along the treatment path. The clinician controls the animation routine through a VCR metaphor, which provides control buttons similar to those on a conventional video cassette recorder. In particular, the VCR metaphor includes a “play” button that, when selected, causes the animation routine to step through all of the images along the treatment path. A slide bar moves horizontally a predetermined distance with each successive image displayed. Each position of the slide bar and each image in the series corresponds to one of the intermediate treatment steps described above. The VCR metaphor also includes a “step forward” button and a “step back” button, which allow the clinician to step forward or backward through the series of images, one key frame or treatment step at a time, as well as a “fast forward” button and a “fast back” button, which allow the clinician to jump immediately to the final image or initial image, respectively. The clinician also can step immediately to any image in the series by positioning the slide bar at the appropriate location. The viewer program allows the clinician to alter the rendered image by manipulating the image graphically. For example, the clinician can reposition an individual tooth by using a mouse to click and drag or rotate the tooth to a desired position. In some implementations, repositioning an individual tooth alters only the rendered image; in other implementations, repositioning a tooth in this manner modifies the underlying data set. In the latter situation, the viewer program performs collision detection to determine whether the attempted alteration is valid and, if not, notifies the clinician immediately. Alternatively, the viewer program modifies the underlying data set and then uploads the altered data set to the remote host, which performs the collision detection algorithm. The clinician also can provide textual feedback to the remote host through a dialog box in the interface display. Text entered into the dialog box is stored as a text object and later uploaded to the remote host or, alternatively, is delivered to the remote host immediately via an existing connection.

The viewer program optionally allows the clinician to isolate the image of a particular tooth and view the tooth apart from the other teeth. The clinician also can change the color of an individual tooth or group of teeth in a single rendered image or across the series of images. These features give the clinician a better understanding of the behavior of individual teeth during the course of treatment.

Another feature of the viewer program allows the clinician to receive information about a specific tooth or a specific part of the model upon command, e.g., by selecting the area of interest with a mouse. The types of information available include tooth type, distance between adjacent teeth, and forces (magnitudes and directions) exerted on the teeth by the aligner or by other teeth. Finite element analysis techniques are used to calculate the forces exerted on the teeth. The clinician also can request graphical displays of certain information, such as a plot of the forces exerted on a tooth throughout the course of treatment or a chart showing the movements that a tooth will make between steps on the treatment path. The viewer program also optionally includes “virtual calipers,” a graphical tool that allows the clinician to select two points on the rendered image and receive a display indicating the distance between the points.

Additionally, various automated analysis applications are provided to help the treatment provider review cases are provided. For example, the analyzer module provides cross sectioning tools that enable vertical, horizontal, and diagonal sectioning to facilitate overbite and overjet views and analysis. The module can also estimate an orthodontic/occlusion index such as the PAR (Peer Assessment Rating) index. In addition to PAR, other metrics such as shape-based metrics or distance-based metrics may be used. These metrics may also include cephalometric data, among others.

The PAR index identifies how far a tooth is from a good occlusion. A score is assigned to various occlusal traits which make up a malocclusion. The individual scores are summed to obtain an overall total, representing the degree a case deviates from normal alignment and occlusion. Normal occlusion and alignment is defined as all anatomical contact points being adjacent, with a good intercuspal mesh between upper and lower buccal teeth, and with nonexcessive overjet and overbite. In PAR, a score of zero would indicate good alignment, and higher scores would indicate increased levels of irregularity. The overall score is recorded on pre and posttreatment dental casts. The difference between these scores represents the degree of improvement as a result of orthodontic intervention and active treatment. The eleven components of the PAR Index are: upper right segment; upper anterior segment; upper left segment; lower right segment; lower anterior segment; lower left segment; right buccal occlusion; overjet; overbite; centerline; and left buccal occlusion. In addition to the PAR index, other indices may be based on distances of the features on the tooth from their ideal positions or ideal shapes.

The module allows the user to experiment with index-reducing movements where all possible movements are attempted, including small movements along each major axis as well as small movements with minor rotations. An index value is computed after each small movement and the movement with the best result is selected. In this context, the best result is the result that minimizes one or more metrics such as PAR-based metrics, shape-based metrics or distance-based metrics. The optimization may use a number of techniques, including simulated annealing technique, hill climbing technique, best-first technique, Powell method, and heuristics technique, among others. Simulated annealing techniques may be used where the index is temporarily increased so that another path in the search space with a lower minimum may be found. However, by starting with the teeth in an almost ideal position, any decrease in the index should converge to the best result.

The module can also analyze how well the teeth fit together when the jaws move (functional occlusion). Jaw motions are simulated by applying a simplified set of movement physics (kinematics) to the dental models. A simplified physical simulation allows the system to focus on motions involving much contact between the jaws. The physical simulation allows the system to render realistic physically correct jaw movements when the jaws come into contact with each other. A range of simulated motion may be supplied using a library of motions. One typical motion supplied by the library is a protrusive motion where the lower jaw is moved forward and backward to bring the front teeth on both jaws into contact with each other. Another motion is a lateral motion found in food chewing. The lateral motion involves moving the jaws side to side. Other motions that may be supplied in the library include motions that are “tooth guided” where the path of the lower jaw is guided by the teeth in contact with each other. The motion simulation may be rerun until the contacts associated with each tooth are acceptable to the treating orthodontist. The tooth model manipulation process can be done subjectively, i.e., the user may simply reposition teeth in an aesthetically and/or therapeutically desired manner based on observations of the final position or based on the simulation of contacts. Alternatively, rules and algorithms may be used to assist the user in repositioning the teeth based on the contacts.

The treatment planning module 3A and virtual planning module 3B allow the user to digitally manipulate teeth to simulate treatment scenarios. Additionally, the modules allow animation of teeth from pre-treatment occlusion to final occlusion. In one embodiment, the module optimizes the occlusion based on six characteristics (Six Keys) that were found to be consistently present in a collection of 120 casts of naturally optimal occlusion. The keys include a molar relationship key, a crown angulation key, a crown inclination key, teeth rotation key, teeth contact point key, and an occlusal plane key. The individual keys provide a complete set of indicators of optimal occlusion, can be judged from tangible landmarks, and can be judged from a facial and occlusal surfaces of the crowns, thus reducing the need for a lingual view for articulating paper to confirm occlusial interfacing. These keys are described in Lawrence F. Andrews, “The six keys to normal occlusion,” Am. J. Orthod. Vol. 62, No. 3 pp. 296-309 (9/72) and in Chapter 3 of his book entitled Straight Wire—The Concept and Appliance (Published by L. A. Wells), the contents of which are incorporated by reference.

The Six Keys are interdependent elements of the structural system of optimal occlusion and are based on similarities in the patterns of angulation, inclination, shape, and relative size (facial prominence) of tooth types. As such, they serve as a base for evaluating occlusion. The Six Keys are used as treatment objectives for patients. The characteristics of the Six Keys are incorporated into the design of appliance to enhance precision and consistency in treatment results.

The process first checks whether optimization is to be done with respect to a molar relationship key. If so, the process checks and applies an appropriate molar relationship. The molar relationship pertains to the occlusion and the interarch relationships of the teeth. The following seven requirements of the molar relationship key are analyzed:

1. The mesiobuccal cusp of the permanent maxillary first molar occludes in the groove between the mesial and the middle buccal cusps of the permanent mandibular first molar.

2. The distal marginal ridge of the maxillary first molar occludes with the mesial marginal ridge of the mandibular second molar.

3. The mesiolingual cusp of the maxillary first molar occludes in the central fossa of the mandibular first molar.

4. The buccal cusps of the maxillary premolars have a cusp-embrasure relationship with the mandibular premolars.

5. The lingual cusps of the maxillary premolars have a cusp-fossa relationship with the mandibular premolars.

6. The maxillary canine has a cusp-embrasure relationship with the mandibular canine and first premolar. The tip of its cusp is slightly mesial to the embrasure.

7. The maxillary incisors overlap the mandibular incisors and the midlines of the arches match.

The cusp-groove and the marginal-ridge conditions of the molars, the cusp-embrasure relationship of the premolars and canines, and incisor overjet can be observed directly from the buccal perspective. A facial axis of the clinical crown (FACC) measurement is used to permit assessment of the lingual-cusp occlusion of the molars and premolars when these teeth are viewed from their mesiobuccal aspect. Correct occlusal interfacing are verified through correct interarch relationship, angulation, and crow inclination. Interarch relationship and angulation are best judged from the buccal perspective; crown inclination for posterior teeth is best judged from the dentition's mesiobuccal perspective. Judging posterior occlusion first from the buccal (for angulation and interarch relationship) then from the mesiobuccal (for inclination) provides a perspective that can be systematically described and quantified. Such information, along with other nonocclusal guidelines, are used to identify occlusal deviations.

A second process for determining final position of the patient's teeth identifies an ideal base model for the final position of the teeth that consists of an arch curve. This model can be selected from a suite of template models, derived from patients with ideal occlusion, or derived from patient under treatment (via the casts, X-rays, a prescription, or data about the patient from other sources). Next, the user of the software places and orients a marker on each tooth, through which the arch curve (or curves) is intended to pass. The curves can be designed so that they should pass through markers placed on the tooth's facial, lingual, or occlusal surface. Multiple arch curves can be used to make the specification of the final position more accurate. The position and orientation of the teeth are adjusted so that the arch curve passes through the marker on each tooth and the teeth do not overlap. Optionally, the teeth can be made to contact each other in this step. Next, where the teeth have multiple markers, the position and orientation of the tooth is set so that the arch curves pass as closely as possible through all markers on each tooth. In another implementation, the markers can be automatically placed and oriented on each tooth. The user can optionally adjust their position and orientation.

The computer can then provide the operator with options in staging the treatment from one stage to another stage, or it can completely generate all stages ranging the initial to final desired stage. The staging can be done automatically by data mining the existing cases currently in a treatment database or by providing the operator with several feasible options using pattern recognition.

Turning now to the treatment fabrication module 4, a fabrication machine is computer controlled to form dental appliances based on intermediate and final data set information received from the treatment planning module. In a distributed environment, the fabrication machine may be located at a remote location and receive data set information from the treatment planning module over a network interface. In a central environment, the fabrication machine is located at a factory and fabricates appliances based on data submitted over the network such as the Internet. The resulting appliances are shipped to the clinician.

In one embodiment, a rapid prototyping device such as a stereolithography machine is used. A suitable rapid prototyping machine is Model SLA-250/50 available from 3D System, Valencia, Calif. The rapid prototyping machine selectively hardens a liquid or other non-hardened resin into a three-dimensional structure which can be separated from the remaining non-hardened resin, washed, and used either directly as the appliance or indirectly as a mold for producing the appliance. The prototyping machine receives the individual digital data sets and produce one structure corresponding to each of the desired appliances. Generally, because the rapid prototyping machine may utilize a resin having non-optimum mechanical properties and which may not be generally acceptable for patient use, it will be preferred to use the prototyping machine to produce molds which are, in effect, positive tooth models of each successive stage of the treatment. After the positive models are prepared, a conventional pressure or vacuum molding machine may be used to produce the appliances from a more suitable material, such as 0.03 inch thermal forming dental material, available from Tru-Tain Plastics, Rochester, Minn. 55902. Suitable pressure molding equipment is available under the tradename BIOSTAR from Great Lakes Orthodontics, Ltd., Tonawanda, N.Y. 14150. The molding machine 250 produces each of the appliances directly from the positive tooth model and the desired material. Suitable vacuum molding machines are available from Raintree Essix, Inc. After production, the plurality of appliances which comprise the system of the present invention are preferably supplied to the treating professional all at one time. The appliances will be marked in some manner, typically by sequential numbering directly on the appliances or on tags, pouches, or other items which are affixed to or which enclose each appliance, to indicate their order of use. Optionally, written instructions may accompany the system which set forth that the patient is to wear the individual appliances in the order marked on the appliances or elsewhere in the packaging. Use of the appliances in such a manner will reposition the patient's teeth progressively toward the final tooth arrangement.

Other embodiments of the fabrication machine for fabricating aligners can employ the following exemplary technologies/methods:

1—Milling the aligner out of block of polymeric material

2—Thermal forming; 1) fabricate a prototype of the arch, 2) thermal form a sheet of polymer over it, and 3) cut, trim & polish it using laser and/or milling machine

3—Using shelling technique to rapid prototype (SLA) the aligner out of biocompatible resin

4—Thermal set; 1) fabricate a prototype of the arch, 2) apply thermal set material over it, and 3) once the material set, cut, trim and polish it using laser and/or milling machine.

Alternatively, in place of the fabrication device to generate retainer-like appliances, a wire/bracket fabrication device such as those available from OraMetrix can be used. In this embodiment, a series of arch wires are generated where the zero force arch wire is the last in the series. Each wire may include bends, loops, slide positioning, and/or other geometric shape to provide a determined amount of tooth movement or tooth anchoring. Having generated the series of wires, brackets, bands, and/or any other orthodontic structures, are placed on at least some of the teeth in accordance with a zero force position. The placement of the bracket is transferred to a three-dimensional digital model of an actual orthodontic structure, and a jig is produced for holding the brackets and a current three-dimensional digital model of the orthodontic structure containing the brackets is obtained.

The treatment feedback module 5 allows the user to monitor treatment and to correct for unexpected variances. In one embodiment, the module 5 incorporates mid-treatment information to the final positioning process. The patient's current position is ascertained by performing a new scan using the data module 1. Each tooth is then matched against a model associated with a prior scan developed at the beginning of the treatment plan. The matching process is based on matching corresponding points between the current scan and the prior scan of the teeth. In most cases, the teeth segmented from the current scan retain the shapes determined at the beginning of the treatment plan, and the matching process is easy because the models should be similar to each other. A final position transform is then applied to the new teeth model. The final position and specification from the prior model is copied to the current model of the patient, and the final position is adjusted based on the new models and/or a new prescription.

FIG. 1B shows an exemplary process for treating the patient at the professional's office. First, the scanner 12 can acquire images of the inner arch, determine the occlusion (50), and based on that the computer 16 separates each tooth object for both the upper and lower arch (52). At that point the doctor could use the software to move the tooth objects so that the final position of the occlusion satisfies the desired prescription of the doctor (54). Optionally, the system can merge the final position of the tooth objects with a patient image for preview purposes (56). As another option, the system allows the user to measure teeth data for treatment planning purposes (58). The computer 16 then generates stages required to treat the teeth (60). Once that is done the computer 16 drives the fabrication machine 20 to generate the aligners. Alternatively, the computer system 16 can send data over the wide area network 102 to a remove system that is capable of fabricating the aligner either to thermal forming means or directly to a 3-D printer that could shell the aligner or milling system that could fabricate the aligners.

Referring now to FIG. 1C, an environment supporting a dental system 100 is shown. The system 100 communicates over a network 102 that can be a local area network or a wide area network such as the Internet.

One or more client computers 104-105 can be connected to the network 102. In one embodiment where the network 102 is the Internet, the client computers execute a suitable browser such as Navigator from Netscape, Inc. and Internet Explorer from Microsoft Corp. By clicking on the highlighted text (or specific graphic image), the user can jump from the current web page to a new web page address associated with the link—with the new page displayed on the screen. In this manner, the user can “surf the web” by clicking on an almost endless succession of links going to page after page all following a common thread as defined by the text or graphic component of the link label.

Through the network 102, the client computers 104-105 can access a dental server 106. The dental server 106 serves a web site, a portal, a vortal, or a content site for providing dental related information to interested parties such as dental patients, dentists, orthodontists, and others. When sensitive information is communicated through the dental server 106, such information is securely encrypted using Secure Sockets Layer (SSL) technology throughout the transaction. The server 106 can be a stand-alone computer or can be a server farm that can distribute processing and communications activity across a computer network so that no single device is overwhelmed. During load balancing, if one server is swamped with requests, excess requests are forwarded to another server with more capacity.

The network 102 connects the dental server 106 to one or more treating professional workstations 108-109. The workstations 108-109 allow treating professionals access to a plethora of services provided by the dental server 106 such as patient treatment and office management, among others. The dental server 106 stores information associated with patient history on-line in a secure manner. The server 106 also allows the treating professional to have a comprehensive view of the patient's treatment history at any time using a suitable browser, eliminating the need to pull treatment files or charts or to look for misfiled or lost charts. The dental server 106 also provides treating professionals with tools to analyze patient data, for example, tools to reconstruct a 3D model of the teeth. For example, using the browser, the treating professional can request the server 106 to animate the progress of the treatment plan. When the treating professional arrives at a prescription or other final designation, the treatment prescription is used to automatically generate appliances, as described in more details below. Further, in addition to aiding professionals in treating patients, the treating professional can perform office management, purchasing and other logistical operations using the browser and the dental server 106.

In addition to communicating with patients and treating professionals, the dental server 106 can communicate with one or more partners 110 using the network 102. The partners 110 can be product suppliers, service providers, or any suitable commercial entities.

One partner 110 can be a financing partner that offers customers with one or more electronic financing options. In one implementation, the financing partner can be a credit card processing company. The credit card processing company can accept a customer's existing credit card or can issue the customer with a new credit card. Further, the credit card can be issued under the name of a third-party bank, the name of the credit card processing company, or the name of the site supported by the dental server 106 under a co-branding arrangement.

The customer enters the sensitive data such as credit card number, shipping address, among others, onto a purchase form. The credit data is then submitted, collected and passed securely through the dental server 106. This data can be processed in real time or can be collected by mail or telephone and then entered by an operator. A processor at the credit card processing company then verifies that the credit card number is valid and is not stolen, among other anti-fraud measures. If the credit card information is valid, the purchase price will be reserved from the issuing bank of the consumer's credit card and allocated to the account associated with the server 106. Periodically, the credit card processor settles all accounts; it is at this time that all monies move. Funds reserved are transmitted from the issuing bank of the cardholder's credit card to the account of the server 106. Also, discount fees are paid from these funds, as they are moving.

Alternatively, the financing partner can debit from the customer's checking account over the Internet. One such check debiting services is the MerchanTrust™ Paperless Checks™ Services, available from Merchant Commerce, Inc. These services provide customers with the convenience of making online purchases by checking account debits, with no manual data entry required of a merchant. In this embodiment, a customer fills in a form at the site with bank information printed at the bottom of his or her personal check. The information is processed as an Electronic Funds Transfer (EFT) to the customer's account using the Automated Clearinghouse (ACH) payment system.

Yet another possible partner 110 is a dental supply retailer providing an on-line shop on the web site to retail dental products to the customers and treating professionals. The retailer can be a co-branding partner that uses the brand name linked or suitably associated with the web site of the server 106 such that users of the server 106 would not know that the on-line shop is actually operated by a third party. The retailer can offer dental products for brushing, flossing, and cleaning of dental implants and bridges. Other dental products include anti-plaque rinse and plaque-fighting toothpaste. The retailer can also sell other health-care-related products such as prescription drugs; non-prescription drugs; personal care; beauty and spa; vitamins, herbs and nutrition; and medical supplies. Additionally, the retailer can serve the needs of the treating professionals by offering products such as brackets, buccal tubes, bands, archwire products, bonding adhesives, hand instruments, systems, supplies and equipment.

Yet another partner 110 can be a shipping partner. The shipping partner delivers dental supply or goods received from a multiplicity of producers and manufacturers for ultimate distribution to each customer. The facilities for warehousing and introduction of goods into a transportation stream for redistribution are the so-called cross docking facilities. The supply or good flows in bulk from a producer or a manufacturer to one or more cross docking facilities owned by either the shipping partner or the operator of the server 106. The items are then be broken into smaller unit sizes and distributed to the customers.

The above list of partners lists only exemplary partners and is not an exhaustive list. Other possible partners include value-added service providers such as third party software providers who provide plug-in viewing and diagnostic enhancements that can be used by the professionals.

The server 106 can perform dynamic targeting and information gathering. The users provide demographic information when they register for our service. The server 106 can track our users' behavior the entire time they are online. As a result, the server 106 can deliver targeted advertisements and measure their effectiveness. For example, users can receive ads from a brokerage firm when they are viewing sites containing stock quotes or financial news, or receive promotions from a bookseller when browsing sites containing book reviews. As such, the dental server 106 can provide a prominent and sustained advertising medium to the community. In contrast to most portal and content sites which display advertising, the site remains with users the entire time they are online. Once users are logged on, the site remains in full view throughout the session, including when they are waiting for pages to download, navigating the Internet and even engaging in non-browsing activities such as sending or receiving e-mail. The constant visibility of the site allows advertisements to be displayed for a specified period of time.

In combination, the dental server 106 forms a hub that links dental clients using client computers 104-105, treating professionals using workstations 108-109, and partners 110 into a living electronic commerce (e-commerce) community.

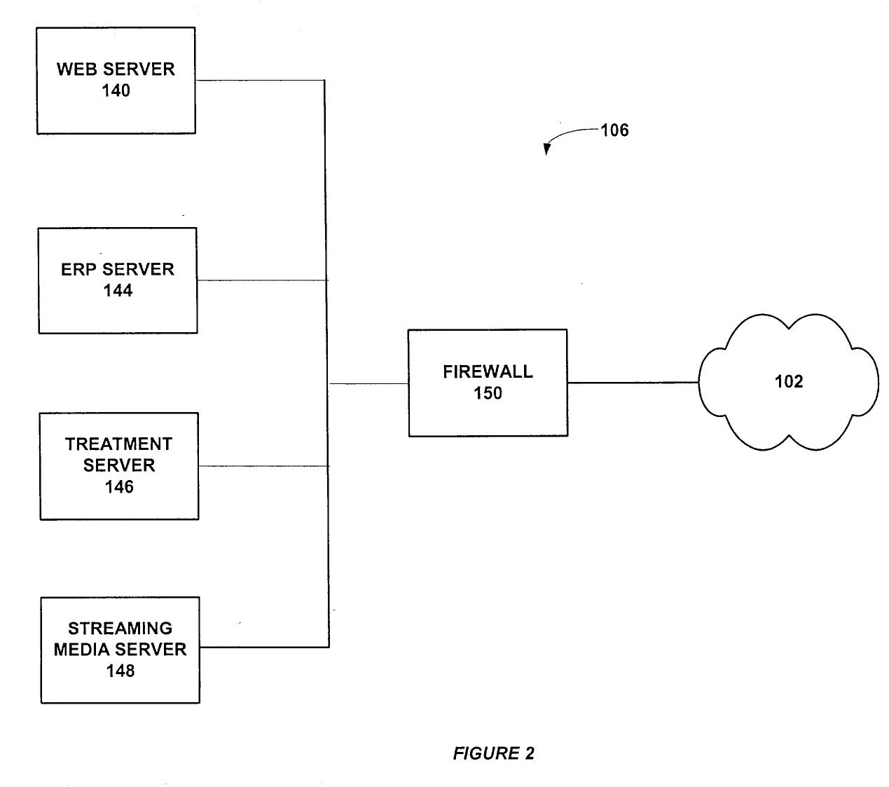

FIG. 2 shows an embodiment of the server 106. The server 106 includes a web server 140, a patient information server 142, a resource planning (RP) server 144 and a streaming server 146. In one embodiment, the RP server 144 runs Microsoft SQL server and provides information relating to a doctor or a patient such as address and history. When a patient's case or static snapshots of the case is needed, the data is pulled from the patient information server 142. When media data such as video needs to be streamed to a requesting client, the streaming server 146 can send the stream. In one implementation, the streaming data is stored in QuickTime format on a Linux-based server running the QuickTime server software.

The servers can be clustered. In one embodiment using Microsoft's Cluster Server, cluster-enabled applications such as Microsoft's SQL Server and Exchange. With Cluster Server, two servers can run applications at the same time. When one server fails, the remaining server handles its application as well as the failed server's applications. Next, the remaining server adopts the IP address of the failed server and mounts one or more data drives that the two systems share. The remaining server is rebooted and applications such as SQL Server can be started and initialized on this server. Persistent clients can re-attach to the server and continue to operate.

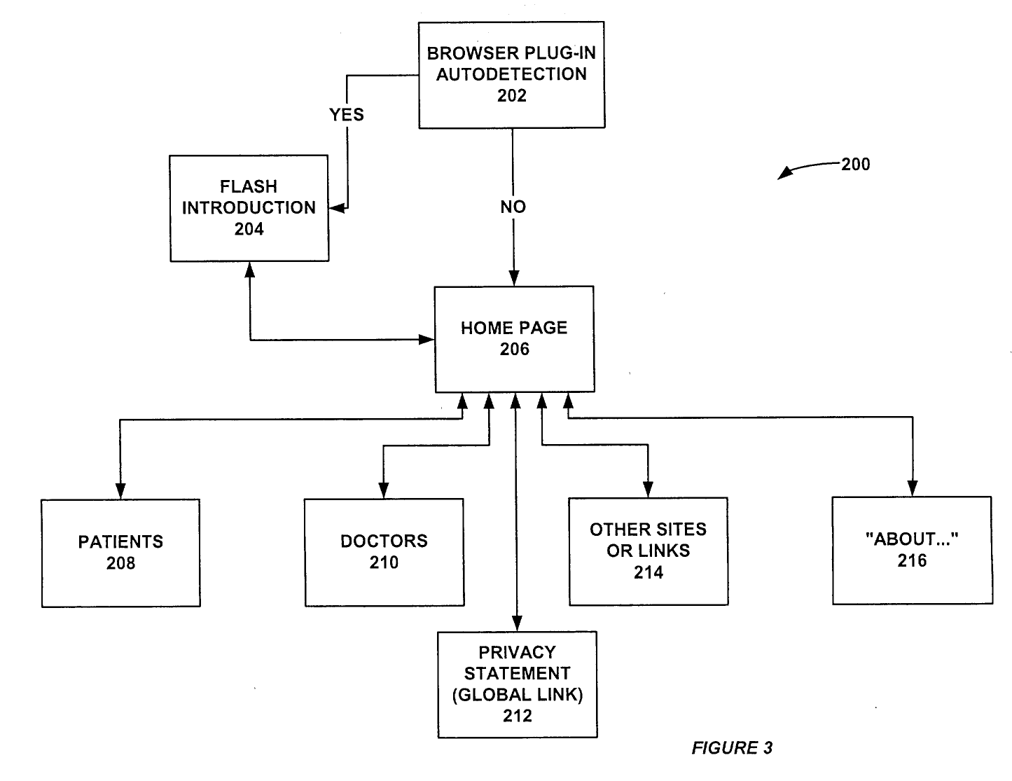

Referring now to FIG. 3, a diagram 200 shows various major functions supported by the dental server 106. First, the process 200 performs an automatic detection for the existence of a browser welcome plug-in (202). If the welcome plug-in exists, an introductory animation (flash) is shown (204). From step 204 or 206, the process 200 shows a home page (208) with one or more links. A link is created by having a word in a text field (or a graphic image on a web page) linked to the location of another web page, via a string of information setting forth the new web page address presented in hypertext transfer protocol (HTTP), among others.

The user can navigate the home page to join a particular site from a constellation of related sites. For instance, the user can navigate to a patient's site (209), a doctor's site (210), a privacy statement site (212), one or more additional sites (214), and an about site (216), among others. The additional sites can be an on-line shopping store that is co-branded with the web site hosted by the server 106, or the on-line shopping store can be directly affiliated with a third party such as planet-rx.com, among others. The additional sites can also be third party value-added providers of products and/or services.

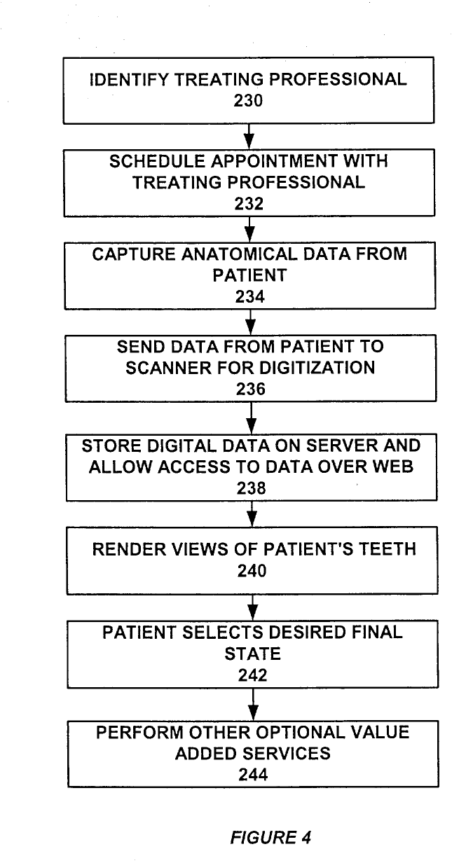

FIG. 4 illustrates an exemplary usage of the system of FIG. 1 from a patient's perspective. First, a prospective client using a client computer 104 visits the web site on the dental server 106 and identifies a treating professional meeting one or more criteria, for example a professional whose location is closest to his or her home address (230). Next, the patient schedules an appointment with the treating professional (232). At the meeting, an assistant captures various anatomical data from the patient by taking digital photographs of the face and teeth, taking x-rays of the front, back, side, and top/bottom of the patient, taking one or more impressions, among others (234). Next, this information is entered into a form on the server 106 (236). The data is then digitized, stored on the server 106, and made available to the treating professionals and the patient over the Internet (238). Next, the server 106 and one or more orthodontic treating persons process the patient data and render the patient's teeth in a plurality of alternative final states (240). Based on the choices, the patient selects a desired final state (242).

In addition to performing orthodontic operations, the server 106 can also perform other value-added services. For example, processes executed by the server 106 can simulate the color of the patient's enamel and show the color of the teeth before and after bleaching (244). Further, processes on the server 106 can simulate the color of the patient's silver fillings (amalgram) and show the teeth after cosmetic work to cover the amalgam (246). After visualizing the effects of the operations, comparing the before and after operations, and reviewing guideline pricing for the orthodontic operation as well as add-ons such as bleaching (248), the patient makes a decision (250).

Once the patient has accepted a particular treatment selection, the server 106 offers the patient with one or more financing options from one of its financial partners (256). Additionally, the server 106 can guide the patient to an on-line shopping store to purchase products relating to his or her dental health (258). For example, the patient can buy cleaning supplies, brushes, and flossing supply at a price competitive to his or her traditional stores. Moreover, the products can be delivered to the patient using one or more delivery partners at a convenient time (260).

FIG. 4 illustrates an exemplary usage of the system of FIG. 1 from a treating professional's perspective. A prospective patient uses a client computer 104 and visits the web site on the dental server 106 (280). The client identifies a treating professional and schedules an appointment with the treating professional (281). Alternatively, a referring dentist can refer the client to the treating orthodontist (282). The referring dentist can visit the web site on the dental server 106 and uses one or more dental esthetic tools to show patients the potential benefits of anterior and posterior esthetic restorations and, if the patient is interested, refers the patient to the treating professional (283).

During an initial examination, the treating professional or an assistant takes a set of digital facial and intraoral images which is uploaded to a secure, collaborative workspace on the dental server 106 (284). The workspace is shared with the referring dentist.

Next, the treating professional generates a dentofacial treatment visualization showing the patient's face and smile before and after treatment (286). The treating professional can also combine the patient's face and an aligner into the intraoral image to show how the inconspicuous the appliance will be (288).

Once the patient requests treatment, the treating professional takes impressions and a bite registration and sends the information to the company (290). The treating professional also takes a lateral ceph and a panorex and uploads them and a treating prescription to the workspace (292). The professional's assistant creates a separate workspace for the patient, uploads selected “before and after” images into it, and invites the patient to review the images (294).

At the company, another professional reviews the records and decides to accept or decline the case (296). The models are then scanned, and the intraoral images are retrieved and used to texture-map enamel and gingiva (298). The data is then sent to the workspace and the treating professional is notified (300).

In one embodiment, the tooth models may be posted on a hypertext transfer protocol (http) web site for limited access by the corresponding patients and treating clinicians. Since realistic models have a large volume of data, the storage and transmission of the models can be expensive and time consuming. To reduce transmission problems arising from the large size of the 3D model, in one embodiment, data associated with the model is compressed. The compression is done by modeling the teeth meshes as a curve network before transmission to the treating professional. Once the curve network is received, the 3D model is reconstructed from the curve network for the treating professional to analyze.

The treating professional can, at his or her convenience, check the setup, and review the information sent in step 300 (301). The treating professionals can use a variety of tools to interpret patient information. For example, the treating professional can retrieve and analyze patient information through a reconstructed 3D model of the patient's teeth and other anatomical structures. The professional can view animations showing the progress of the treatment plan to help the treating physician visualize the pace of treatment. Using these tools, the treating professional can easily and quickly view and/or edit the treatment plan.

If necessary, the treating professional can adjust one or more teeth positions at various intermediate stages of treatment (302). A variety of diagnostic decision-support capabilities such as automated teeth collision detection can be used to aid the treating professional in adjusting the teeth positions.

When the treating professional arrives at a prescription or other final designation, the treatment information is automatically collected by the system over the Internet, thus eliminating the cost and delay associated with the traditional physical shipping of patient information (304). These modifications are then retrofitted onto the dataset used to generate the aligners (306).

FIG. 3 shows a process 400 associated with a viewer that allows the treating professional to visualize the patient's teeth over the network 102 such as the Internet. In one embodiment, during start-up, a browser checks for a viewer plug-in module embodying the process 400 in a “plugins” subdirectory (Windows) or Plug-ins folder (Mac OS) in the same folder or directory as the browser (402). If the viewer plug-in module is available, the browser looks for a MIME type and extension info from the version resource. Through a TYPE attribute, the browser knows the MIME type and can load a registered plug-in first and, if there are no matches for the MIME type, the browser looks for a helper application.

Once the viewer plug-in is identified, the browser loads the viewer plug-in code into memory (404); initializes the viewer plug-in (406); and creates a new instance of the viewer plug-in (408). When the professional leaves the site or closes the window, the viewer plug-in instance is deleted. When the last instance of the viewer plug-in is deleted, the plug-in code is unloaded from memory.

Next, data files are downloaded to the viewer plug-in (410). In one implementation, the viewer plug-in downloads a data file from the dental server 102 using a suitable protocol such as a file transfer protocol (FTP). The viewer plug-in uses the downloaded file to present the treatment plan graphically to the clinician. The viewer plug-in also can be used by the treatment plan designer at the host site to view images of a patient's teeth. FIG. 4 shows an exemplary user interface for the viewer plug-in of FIG. 3. The professional can change views, select a particular tooth and change its position as desired (412).

3-D images of various orthodontic views can then be rendered after each instruction from the treating professional is received (414). In this process, an origin point, or “look from” point associated with a camera view is generated. Next, a “look at” point or a focus point associated with the camera view is determined. In this system, the line from LookFromPoint to LookAtPoint defines the direction the camera is shooting at. Additionally, a camera Z vector, or up vector, is determined.

Exemplary pseudo code implementations for generating various orthodontic views is shown below. With reference to the pseudo code, the code defines a bounding box of one mold (2 arches) which is the smallest cube containing the molds geometry.

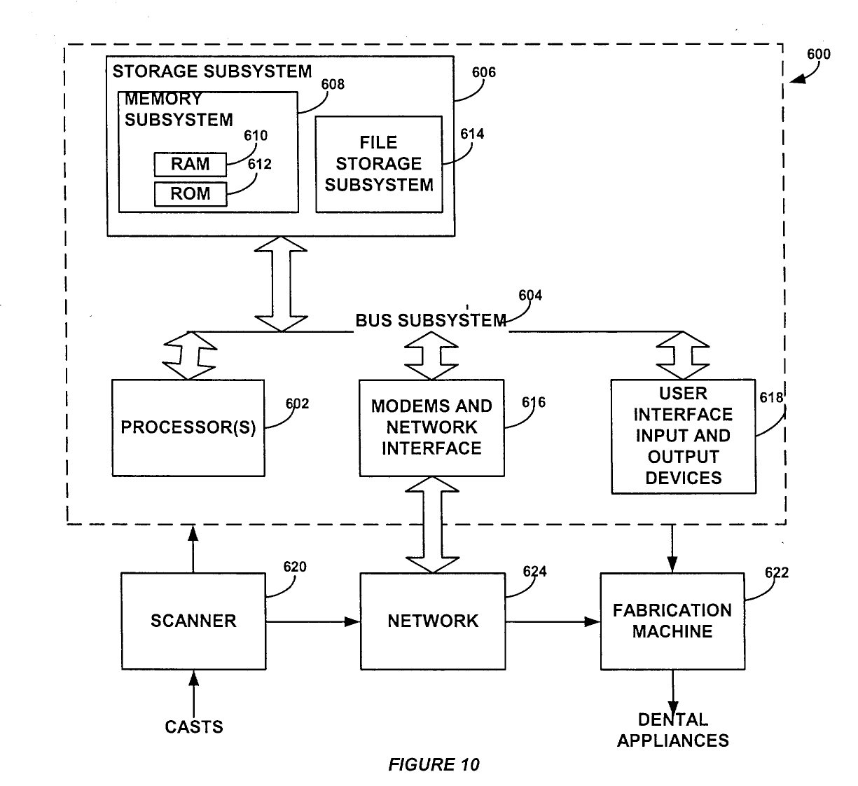

Once the intermediate and final data sets have been created, the appliances may be fabricated as illustrated in FIG. 10. Common fabrication methods employ a rapid prototyping device 501 such as a stereolithography machine. A particularly suitable rapid prototyping machine is Model SLA-250/50 available from 3D System, Valencia, Calif. The rapid prototyping machine 501 selectively hardens a liquid or other non-hardened resin into a three-dimensional structure which can be separated from the remaining non-hardened resin, washed, and used either directly as the appliance or indirectly as a mold for producing the appliance. The prototyping machine 501 receives the individual digital data sets and produces one structure corresponding to each of the desired appliances. Generally, because the rapid prototyping machine 501 may utilize a resin having non-optimum mechanical properties and which may not be generally acceptable for patient use, the prototyping machine typically is used to produce molds which are, in effect, positive tooth models of each successive stage of the treatment. After the positive models are prepared, a conventional pressure or vacuum molding machine 551 is used to produce the appliances from a more suitable material, such as 0.03 inch thermal forming dental material, available from Tru-Tain Plastics, Rochester, Minn. 55902. Suitable pressure molding equipment is available under the trade name BIOSTAR from Great Lakes Orthodontics, Ltd., Tonawanda, N.Y. 14150. The molding machine 551 produces each of the appliances directly from the positive tooth model and the desired material. Suitable vacuum molding machines are available from Raintree Essix, Inc.

After production, the appliances can be supplied to the treating professional all at one time. The appliances are marked in some manner, typically by sequential numbering directly on the appliances or on tags, pouches, or other items which are affixed to or which enclose each appliance, to indicate their order of use. Optionally, written instructions may accompany the system which set forth that the patient is to wear the individual appliances in the order marked on the appliances or elsewhere in the packaging. Use of the appliances in such a manner will reposition the patient's teeth progressively toward the final tooth arrangement.

Because a patient's teeth may respond differently than originally expected, the treating clinician may wish to evaluate the patient's progress during the course of treatment. The system can also do this automatically, starting from the newly-measured in-course dentition. If the patient's teeth do not progress as planned, the clinician can revise the treatment plan as necessary to bring the patient's treatment back on course or to design an alternative treatment plan. The clinician may provide comments, oral or written, for use in revising the treatment plan. The clinician also can form another set of plaster castings of the patient's teeth for digital imaging and manipulation. The clinician may wish to limit initial aligner production to only a few aligners, delaying production on subsequent aligners until the patient's progress has been evaluated.

FIG. 11 is a simplified block diagram of a data processing system 600 that may be used to develop orthodontic treatment plans. The data processing system 600 typically includes at least one processor 602 that communicates with a number of peripheral devices via bus subsystem 604. These peripheral devices typically include a storage subsystem 606 (memory subsystem 608 and file storage subsystem 614), a set of user interface input and output devices 618, and an interface to outside networks 616, including the public switched telephone network. This interface is shown schematically as “Modems and Network Interface” block 616, and is coupled to corresponding interface devices in other data processing systems via communication network interface 624. Data processing system 600 could be a terminal or a low-end personal computer or a high-end personal computer, workstation or mainframe.

The user interface input devices typically include a keyboard and may further include a pointing device and a scanner. The pointing device may be an indirect pointing device such as a mouse, trackball, touchpad, or graphics tablet, or a direct pointing device such as a touchscreen incorporated into the display, or a three dimensional pointing device, such as the gyroscopic pointing device described in U.S. Pat. No. 5,440,326, other types of user interface input devices, such as voice recognition systems, can also be used. User interface output devices typically include a printer and a display subsystem, which includes a display controller and a display device coupled to the controller. The display device may be a cathode ray tube (CRT), a flat-panel device such as a liquid crystal display (LCD), or a projection device. The display subsystem may also provide non-visual display such as audio output.

Storage subsystem 606 maintains the basic required programming and data constructs. The program modules discussed above are typically stored in storage subsystem 606. Storage subsystem 606 typically comprises memory subsystem 608 and file storage subsystem 614.

Memory subsystem 608 typically includes a number of memories including a main random access memory (RAM) 610 for storage of instructions and data during program execution and a read only memory (ROM) 612 in which fixed instructions are stored. In the case of Macintosh-compatible personal computers the ROM would include portions of the operating system; in the case of IBM-compatible personal computers, this would include the BIOS (basic input/output system).

File storage subsystem 614 provides persistent (non-volatile) storage for program and data files, and typically includes at least one hard disk drive and at least one floppy disk drive (with associated removable media). There may also be other devices such as a CD-ROM drive and optical drives (all with their associated removable media). Additionally, the system may include drives of the type with removable media cartridges. The removable media cartridges may, for example be hard disk cartridges, such as those marketed by Syquest and others, and flexible disk cartridges, such as those marketed by Iomega. One or more of the drives may be located at a remote location, such as in a server on a local area network or at a site on the Internet's World Wide Web.

In this context, the term “bus subsystem” is used generically so as to include any mechanism for letting the various components and subsystems communicate with each other as intended. With the exception of the input devices and the display, the other components need not be at the same physical location. Thus, for example, portions of the file storage system could be connected via various local-area or wide-area network media, including telephone lines. Similarly, the input devices and display need not be at the same location as the processor, although it is anticipated that personal computers and workstations typically will be used.

Bus subsystem 604 is shown schematically as a single bus, but a typical system has a number of buses such as a local bus and one or more expansion buses (e.g., ADB, SCSI, ISA, EISA, MCA, NuBus, or PCI), as well as serial and parallel ports. Network connections are usually established through a device such as a network adapter on one of these expansion buses or a modem on a serial port. The client computer may be a desktop system or a portable system.

Scanner 620 is responsible for scanning casts of the patient's teeth obtained either from the patient or from an orthodontist and providing the scanned digital data set information to data processing system 300 for further processing. In a distributed environment, scanner 620 may be located at a remote location and communicate scanned digital data set information to data processing system 600 via network interface 624.

Fabrication machine 622 fabricates dental appliances based on intermediate and final data set information received from data processing system 600. In a distributed environment, fabrication machine 622 may be located at a remote location and receive data set information from data processing system 600 via network interface 624.

The invention has been described in terms of particular embodiments. Other embodiments are within the scope of the following claims. For example, the three-dimensional scanning techniques described above may be used to analyze material characteristics, such as shrinkage and expansion, of the materials that form the tooth castings and the aligners. Also, the 3D tooth models and the graphical interface described above may be used to assist clinicians that treat patients with conventional braces or other conventional orthodontic appliances, in which case the constraints applied to tooth movement would be modified accordingly.

What is claimed is:

1. A computer-implemented method for treating a patient, comprising:
digitally scanning a patient's teeth;
analyzing the scanned data;
planning the treatment;
fabricating a device to treat the patient; and
incorporating treatment outcome as feedback.

2. The method of claim 1, further comprising scanning the teeth using one of a digital camera, an X-ray scanner, a computer-aided tomographic (CT) scanner, and a magnetic resonance imaging (MRI) scanner.

3. The method of claim 1, further comprising separating each tooth from the scanned teeth.

4. The method of claim 1, further comprising manipulating and setting each tooth in a desired tooth position.

5. The method of claim 1, further comprising generating one or more staging options to move the teeth.

6. The method of claim 1, further comprising:
generating an image of the teeth in its desired position; and
merging the image of the teeth in its desired position with a patient image.

7. The method of claim 1, further comprising allowing measurements to each tooth.

8. The method of claim 1, further comprising milling each appliance from a polymeric material.

9. The method of claim 1, further comprising thermal forming each appliance.

10. The method of claim 1, further comprising forming one or more wires to move the teeth.

11. The method of claim 1, further comprising cutting, trimming and polishing the appliance.

12. The method of claim 1, wherein the appliance is prepared using a laser machine.

13. The method of claim 1, wherein the appliance is prepared using a milling machine.

14. The method of claim 1, further comprising shelling a negative of the appliance.

15. The method of claim 1, further comprising shelling a positive of the appliance.

16. The method of claim 1, further comprising shelling the aligner from a bio-compatible resin.

17. The method of claim 1, further comprising thermal setting the appliance.

18. The method of claim 1, further comprising:
applying a thermal set material to form the appliance; and
preparing the appliance for use.

19. An apparatus for treating patient, comprising:
a data capture module,
an analyzer module;
a treatment planning module;
a treatment fabrication module to control a fabrication machine; and
a treatment feedback module; and
means for configuring equipment from one or more vendors and communicating data among the modules.

20. The apparatus of claim 19, wherein the fabrication machine mills the appliance from a block of polymeric material.

21. The apparatus of claim 19, wherein the fabrication machine is a thermal forming machine.

22. The apparatus of claim 19, further comprising a trimming machine to receive and trim the appliances.

23. The apparatus of claim 19, wherein the trimming machine is a laser machine.

24. The apparatus of claim 19, wherein the trimming machine is a milling machine.

25. The apparatus of claim 19, wherein the fabrication machine shells a positive version of an appliance.

26. The apparatus of claim 19, wherein the fabrication machine shells a negative version of an appliance.

27. The apparatus of claim 19, wherein the fabrication machine fabricates appliances using a bio-compatible resin.

28. The apparatus of claim 19, wherein the fabrication machine comprises a thermal setting machine.

29. The apparatus of claim 19, further comprising a virtual health-care electronic commerce community, including:
a network to communicate information relating to the community;
one or more patients coupled to the network;
one or more treating professionals coupled to the network; and
a server coupled to the network, the server storing data for each patient and performing patient data visualization in response to a user request.

30. The apparatus of claim 29, wherein the treating professional views one or more of the following patient data visualization over the network: a right buccal view; a left buccal view; a posterior view; an anterior view; a mandibular occlusal view; a maxillary occlusal view; an overjet view; a left distal molar view; a left lingual view; a lingual incisor view; a right lingual view; a right distal molar view; an upper jaw view; and a lower jaw view.

31. The apparatus of claim 29, wherein the treating professionals include dentists or orthodontists.

32. The apparatus of claim 29, further comprising one or more partners coupled to the network.

33. The apparatus of claim 29, wherein the partners include a financing partner.

34. The apparatus of claim 29, wherein the partners include a supplier.

35. The apparatus of claim 29, wherein the partners include a delivery company.

36. The apparatus of claim 29, wherein the treating professionals perform office management operations using the server.

37. The community of claim 8, wherein the office management operations include one or more of the following: patient scheduling, patient accounting, and claim processing.

38. The apparatus of claim 29, wherein the patients and the treating professionals access the server using browsers.

39. A computer-implemented method for performing dental-related electronic commerce, comprising:
capturing dental data from one or more third-party scanners;
communicating treatment data among one or more modules supplied by different vendors using XML;
displaying a three-dimensional computer model of the teeth at the treating professional computer using a browser;
selecting a vendor based on the vendor's treatment modality and transmitting the computer model from the treating professional computer to the vendor's server; and
generating an appliance to treat the patient based on the computer model of the teeth.

40. The method of claim 39, wherein the vendor fabricates either a dental wire customized to a patient or an appliance having a geometry selected to reposition the teeth from a first to a second arrangement

41. The method of claim 40, further comprising marking at least some of the wires or appliances to indicate their order of use.
